(19) United States
(12) Patent Application Publication
(10) Pub. No.: US 2023/0243129 A1
(43) Pub. Date: Aug. 3, 2023

(54) SYSTEM AND METHOD FOR MEASURING MATERIAL SWELL

(71) Applicant: Caterpillar Inc., Peoria, IL (US)

(72) Inventors: Christopher WRIGHT, Peoria, IL (US); Justin L. STEINLAGE, Mackinaw, IL (US)

(73) Assignee: Caterpillar Inc., Peoria, IL (US)

(21) Appl. No.: 17/590,512

(22) Filed: Feb. 1, 2022

(51) Int. Cl. E02F 9/26; E02F 3/32; E02F 3/43; G01F 22/00; G06T 7/62; G06T 7/50; G06V 20/56

(52) U.S. Cl. CPC E02F 9/262; E02F 3/32; E02F 3/431; G01F 22/00; G06T 7/62; G06T 7/50; G06V 20/56; G01S 19/42

(57) ABSTRACT

A system and method for measuring material swell of material loaded in a dump vehicle using a work machine that includes a frame, an engine, a ground engaging element, a working mechanism and an imaging device. The imaging device provided on the work machine identifies the dump vehicle at a landscape site, and scans the site and the dump vehicle continuously using continuous 3D mapping. The imaging device scans continuously during operation of the work machine as the work machine removes a load of material from the bank of landscape or site with the working mechanism and transfers the load into the dump vehicle. The imaging device calculates the bank volume of the load removed from the site and the excavated volume of the load transferred in the dump vehicle to determine the material swell of the load as the work machine operates.

### TECHNICAL FIELD

The present disclosure generally relates to a system and method of measuring the material swell of bank material removed from a landscape by a work machine as it excavates material from a site and transfers the excavated material to a dump vehicle.

### BACKGROUND

Earth moving equipment such as backhoes, front-end loaders, and excavators are used to move earth, soil and other material from a dig site or landscape. When excavating or removing material from a dig site or bank of landscape, the material breaks up into different clumps and size particles creating voids that reduce the weight per volume. The swell % value is the percentage of original volume that a material increases when it is removed from its bank state and becomes loose.

Determining the material swell of material removed from a dig or landscape site is valuable in avoiding overloading dump vehicles, such as dump trucks. Dump vehicles have threshold limits on the amount of material that the vehicle can physically hold. Dump vehicles must also comply with legal weight limits set by state and federal regulations for use on local and federal roads. Overloading a dump vehicle with earth material can severely damage a truck and cause the truck to be damaged and/or inoperable. Similarly, an overloaded truck can damage roadways not built for use beyond certain weights and results in significant government fines.

It is the desire to know the volume of the material being placed in dump vehicles by the earth moving equipment during operation to avoid overloading the dump vehicle which removes the material from the site location. It is also desirable to know the volume of the material being placed in dump vehicles to comply with local and federal highway road regulations.

Traditional methods of determining the volume of material removed from a specific landscape site require computer software for creating digital models of the geography or topography of a site gathered by conventional surveying, aerial photography, or kinematic GPS surveying techniques. Other methods have made attempts to measure the volume of material removed from a bank by a work machine. For example, U.S. Pat. No. 6,085,583 to Oward discloses a method of using a representation of the excavation site and estimating the volume of material captured by a bucket of a digging machine using the trajectory of the bucket and the shape of the excavation site to determine when the bucket has reached a desired capacity. However, this method requires many assumption and results in less accurate volume measurements.

In another example, US Patent Publication No. 20210148086A1 to Bell discloses a system of autonomous or semi-autonomous earth shaping vehicles capable of filling earth into a fill location in a dig site. A first earth shaping vehicle configured with a hauling tool carrying a volume of earth navigates to the fill location. At the fill location, the first earth shaping vehicle navigates over a target tool path to fill earth from the hauling tool into the fill location. As the first earth shaping vehicle fills earth into the fill location, a measurement sensor coupled to the first earth shaping vehicle measures a compaction level of earth filled into the fill location. If the measured compaction level is determined to be below a threshold compaction level, the first earth shaping vehicle communicates a request for a second earth shaping vehicle configured with a compaction tool to compact earth in the fill location. A fill estimate engine is used to generate the point cloud representation of the current state of the site gathered using spatial sensors to determine a pre-excavation volume of earth in a dug hole and accesses, from a central computer or a remote server, a swell factor of the earth relating the volume of earth in the tool to the pre-excavation volume of earth in the hole. Using the pre-excavation volume of earth in the hole and the swell factor characteristic of the earth, the fill estimate engine estimates the volume of earth in the tool.

For earth moving equipment conducting the removal of material from a specified site, it is desirable to know the material swell of material removed from a site and transferred to a dump vehicle in real time during operation of the earth moving equipment to obtain an accurate material swell measurement, rather than relying on pre-loaded or pre-existing data which may be inaccurate.

### Summary of the Disclosure

In an aspect of the present disclosure a work machine for measuring the material swell is provided. The work machine comprises a frame, a ground engaging element supporting the frame for movement, an engine mounted in the frame to power the work machine, a working mechanism extending from the frame comprising a bucket; and at least one imaging device for measuring a material swell of a material removed from a site and transferred to a dump vehicle during operation of the work machine.

In another aspect of the present disclosure a system is disclosed comprising a dump vehicle, a work machine comprising a frame, a ground engaging element supporting the frame for movement; an engine mounted in the frame and a working mechanism extending from the frame comprising a bucket. The working mechanism further comprise at least one imaging device for measuring the material swell of a load of material removed from a site during operation of the work machine. The imaging device calculates the material swell of the load by continuously scanning images of the site and the dump vehicle during operation of the work machine as the work mechanism removes a load of material from the site and transfers the load in the dump vehicle. The bank volume of the load removed from the site and the excavated volume of the load transferred in the dump vehicle is measured from the disparity between images scanned by the imaging device to determine the material swell of the load of material.

In another aspect of the present disclosure, a method of measuring material swell of material loaded in a dump vehicle using a work machine is disclosed. The method includes providing an imaging device on the work machine. Scanning the site continuously with the imaging device. Scanning the dump vehicle continuously with the imaging device. Removing a load of material from the site with a work mechanism on the work machine. Calculating the bank volume of the load removed from the site. Transferring the load into the dump vehicle. Calculating an excavated volume of the load transferred in the dump vehicle. Calculating the material swell of the load from the bank volume and excavated volume.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a work machine in accordance with the present disclosure.

FIG. 2 is a schematic view of a work machine at a dig site, according to an embodiment.

FIG. 3 is a schematic view of a work machine transferring material to a dump vehicle, according to an embodiment of the present disclosure.

FIG. 4 is a schematic view of the camera system, according to an embodiment of the present disclosure.

FIG. 5 is a schematic view of the cameral system mounted on a portion of a work machine, according to an embodiment of the present disclosure.

FIG. 6 is a representation of sitemaps and corresponding disparity map generated of the site for determining the bank volume, according to an embodiment.

FIG. 7 is a representation of sitemaps and corresponding disparity map generated of the dump bed for determining the excavated volume, according to an embodiment.

FIG. 8 is a flow chart of the method of the present invention, according to an embodiment.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

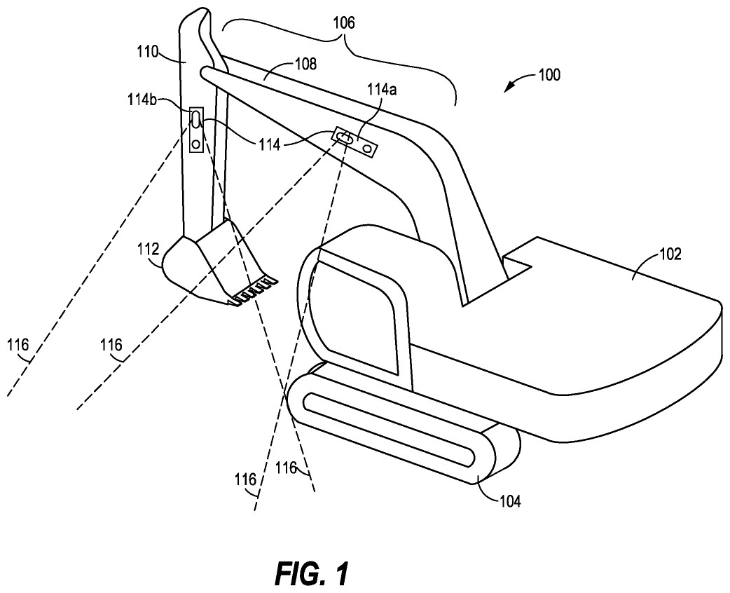

Referring now to FIG. 1, an exemplary work machine 100 is shown, illustrated as an excavator, and may be used, for example, for removing earth, soil, and other material from a landscape. Excavators are heavy equipment designed to move earth material from the ground or landscape at a dig site. Excavators are typically large and capable of excavating large volumes of earth at a single time by scraping or digging earth from beneath the ground or landscape surface. While the following detailed description describes an exemplary aspect in connection with the excavator, it should be appreciated that the description applies equally to the use of the present disclosure in other machines as well.

The work machine 100 comprises a frame 102 containing an engine 103 supported on a ground engaging element 104 illustrated as continuous tracks. It should be contemplated that the ground engaging element 104 may be any other type of ground engaging element 104 such as, for example, wheels, etc. The work machine 100 further includes a working mechanism 106 for conducting work, such as, for example, excavating landscapes or otherwise moving earth, soil, or other material. The working mechanism 106 includes a boom 108, an arm 110, and a bucket 112 used to remove earth, soil, and other material from a landscape site.

The work machine 100 further comprises an imaging device 114 for generating 3D site maps of the landscape during removal of material from a landscape site during operation of the work machine 100. The imaging device 114 may be positioned on the working mechanism 106 to obtain a field of view 116 at a landscape site. The imaging device 114 includes a plurality of imaging devices 114 and are positioned on the work machine 100 to capture images in its field of view 116 during operation of the work machine 100.

In the illustrated embodiment, the plurality of imaging devices 114 include a first imaging device 114a mounted on the boom 108, and a second imaging device 114b mounted on the arm 110. In other embodiments, there may be at least four imaging devices 114 with at least one imaging device 114 mounted on each side of the boom 108 and the arm 110. Imaging devices 114 may include stereo cameras, smart cameras, or smart vision systems having a dedicated processor onboard, including video processing acceleration provided by Field programmable Gate array (FPGA), digital signal processor (DSP), general purpose graphics processing unit (GP-GPU), or any other suitable microprocessor with supporting application software, capable of determining depth and volume from images or real-time videos.

In the illustrated embodiment, the first imaging device 114a is installed on the boom 108 and captures continuous images or videos in its field of view 116 of the landscape where the work machine 100 is operating. The second imaging device 114b is installed on the arm 110 and obtains continuous images or videos in its field of view 116 of the landscape where the work machine 100 is operating.

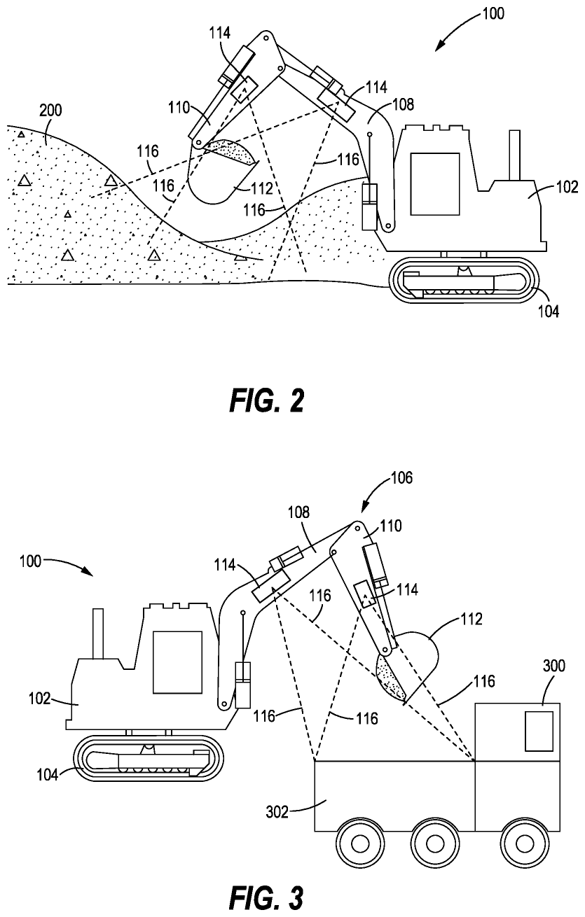

Referring now to FIG. 2, the work machine 100 is depicted schematically, illustrated as an excavator, at a site 200. The site 200 can be a bank of landscape, terrain, or other environment of earth, soil, or other material. The earth moving equipment are generally operated by a human operator, but may be autonomous.

Turning to FIG. 3, the work machine 100 is depicted transferring material to a dump vehicle 300. The dump vehicle 300 may be a dump truck or other common truck comprising a dump bed 302 capable of containing and removing material from the site 200 e.g. via road, highway, etc. The imaging device 114 integrated on the work mechanism 106 uses its field of vision 116 to capture images of the dump vehicle 300 and the dump bed 302 to analyze the volume in the dump bed 302. The imaging device 114 may also identify the dump vehicle 300 by image recognition and/or vehicle fiducial marking, and the like, and may recall features of the dump vehicle 300 such as weight and volume threshold limits, towing capacity, and the like.

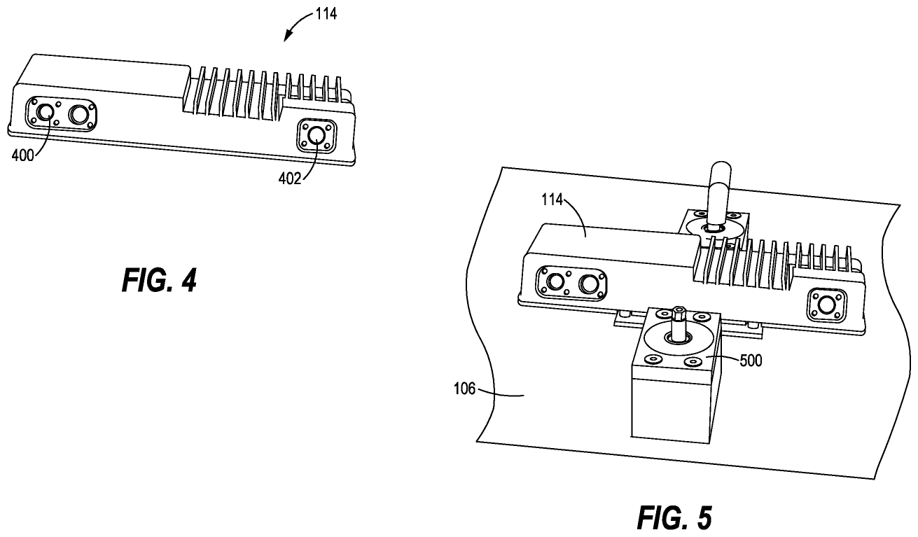

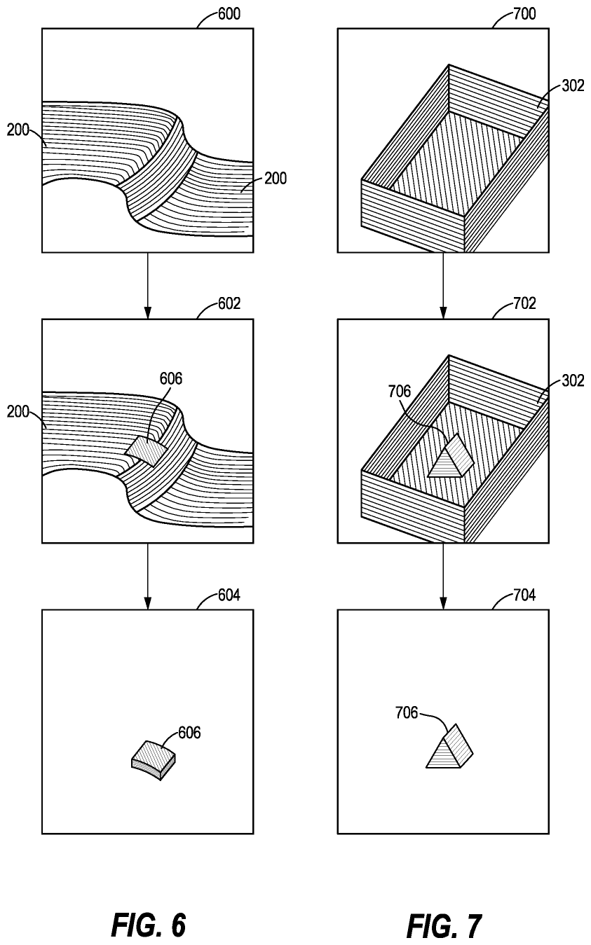

Referring to FIG. 4, an imaging device 114 is depicted. In the illustrated embodiment, the imaging device 114 is a stereo camera comprising at least one monochrome camera lens 400 and at least one color camera lens 402. The stereo cameras equipped with at least one monochrome camera lens 400 allows the imaging device 114 to record each position on an image and show a different amount of light. The monochrome features include all forms of black-and-white photography generally known in the arts. The stereo camera equipped with may also be equipped with at least one color camera lens 402 that includes all known color hues.

Referring to FIG. 5, the imaging device 114 is depicted on a mount 500 on a portion of the work mechanism 106 of the work machine 100. The mount 500 may be a magnetic mount, or of another generally known mount to integrate the imaging device 114 on the working mechanism 106. According to one embodiment, the mount 500 may integrate the imaging device 114 on the boom 108 or the arm 106 of the work mechanism 106 as depicted in FIGS. 1-3.

The imaging device 114 utilizes a 3D point cloud system generally known in the arts that stiches points together to create the 3D cloud map of the site 200 and the dump bed 302. The imaging device 114 perceives the terrain of the site 200 in three-dimensions (3D) with vision capable of determining the depth and distance of objects around the work machine 100 in the imaging device's 114 field of view 116 by continuously mapping. Continuous mapping refers to a continuous function between two images of topological spaces, generally known in the arts. The continuous mapping allows for detecting the spatial context of the terrain. The imaging device 114 may determine the volume of the material removed at a site 102 and transferred to a dump bed 302 by generating a 3D point map through 3D continuous mapping and generating a disparity map between new and previous 3D point maps. 3D cloud maps are used in real-time to estimate the volume removed by each dig and transfer of the work machine 100. The imaging device 114 may be capable of capturing the site 200 terrain during the day and at night, with or without color.

As illustrated in one embodiment of a work machine 100, the imaging device 114 on an excavator may consist of at least two stereo cameras placed on either side of the boom 106 and arm 110 of the work mechanism 106 to obtain an acceptable field of view 116 of the site. In another embodiment, the imaging device 114 includes a set of four stereo camera modules mounted on each side of the boom 106 and/or stick 110. The stereo camera imaging devices 114 uses the field of view 116 of the environment around the excavator at the site 200 to generate 3D point maps continuously. Stereo cameras have features which transform camera images into 3D depth maps and point clouds, and delivers them at high frame rates, transforming pixel data into accurate range measurements. Consequently, the disclosure may produce both an accurate depth map and high-quality images of the site 200 terrain and dump bed 302.

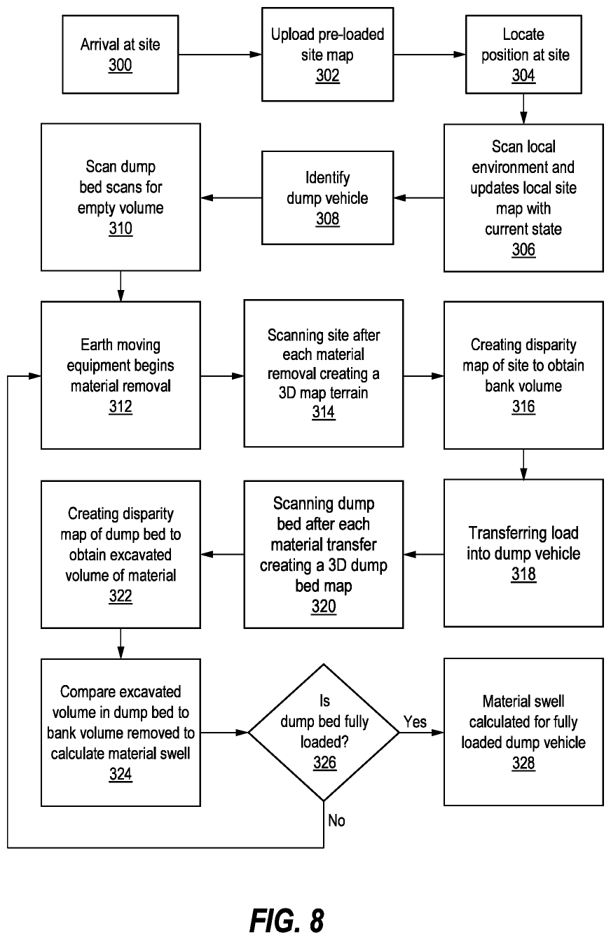

Now referring to FIGS. 7 and 8, a set of representative site maps and disparity maps are shown of the site 200 and the dump bed 302 respectively. A disparity map refers to the pixel difference or motion between a pair of images, generally known in the arts.

As the work machine 100 operates, the imaging device 114 continuously scans the environment around the work machine 100 as it removes material from the site 200. The imaging device 114 scans the site 200, outputs 3D point clouds, and creates a first site scan 600. The first site scan 600 is generated before removing material from the site 200 and a new site scan 602 is generated after the material is removed. The imaging device 114 compares the 3D image data of the starting site scan 600 and new site scan 602 to generate a disparity site map 604 to measure a bank volume 606 of the material removed from the site 200. The disparity site map 604 computes the difference between the starting site scan 600 and new site scan 602 using generally known computing methods to determine the bank volume 606 of material removed by the work machine 100.

In one embodiment, the work machine 100 removes material from a bank of landscape at a site 200 and transfers the removed material into the dump bed 302 of the dump vehicle 300. As the work machine 100 fills the dump bed 302 with the removed bank material 606, the imaging device 114 records the volume of the material transferred in the dump bed 302 of the dump vehicle 300.

The imaging device 114 also outputs 3D point clouds to creates a first bed scan 700 of the dump bed 302 before transferring the bank volume 606 in the dump bed 302 and generates a new bed scan 702 after the material is transferred. The imaging device 114 compares the first bed scan 700 and new bed scan 702 to generate a disparity bed map 704 to measure an excavated volume 706 of the material removed from the site 200. The disparity bed map 704 computes the difference between the first bed scan 700 and new bed scan 702 using generally known computing methods to determine the excavated volume 706 of material transferred by the work machine 100 in the dump vehicle 300. The disparity bed map 704 demonstrates the volume of the load of material transferred into the dump bed 302.

The excavated volume 706 of material is the loose volume of material removed from the site 200. As the bank volume 606 is transferred into the dump bed 302 the excavated material is loosened into a larger excavated volume 706. When the excavated volume 706 is transferred into the dump bed 302, the available volume in the dump bed 302 is reduced and the imaging device 114 tracks the volume. The available weight allowed by the dump vehicle 300's towing capacity may be recalled to prevent the work machine 100 from transferring additional material in the dump bed 302 and prevent overloading damage to the dump vehicle 300.

At the end of each load, the excavated volume 706 in the dump bed 302 is compared to the bank volume 706 of the material removed from the site 200 to determine the material swell. The material swell=(Volume of load transferred in dump vehicle)/(Volume of material removed from site)=(Excavated Volume 706)/(Bank Volume 606). The material swell can be calculated per scoop and per filled dump vehicle 300. A total material swell for the filled dump vehicle 300 may be the average of material swells for each load transferred in a dump vehicle 300.

The imaging device 114 may have capability to identify the dump vehicle 300 for determining the volume and the weight limits of the dump vehicle 300 to prevent overloading by using the material swell. The work machine 100 cycles back and forth between the site 200 and dump vehicle 300 until the dump bed 302 is fully loaded and there is no available volume for additional excavated material in the dump bed 302. The work machine 100 may cycle back and forth between the site 200 and dump bed 302 until the dump vehicle 300 is at maximum weight and cannot carry additional material.

The material swell for the each load of material removed and transferred in the dump bed 302 may be tagged with a timestamp, GPS location of the removal site, and vehicle identification numbers for future use. The work machine 100 may be equipped with a GPS system or other common geographic location device or features.

### Industrial Applicability

In general, the present disclosure can find applicability in many instances, including but not limited to excavation, agricultural, moving, farming, and the like. While the depicted embodiment is shown as described in general with an excavator and a dump truck it is to be understood that these are only exemplary and can be used with equal efficiency with many other work machines such as, but not limited to, backhoes, front end loaders, dump lines, mining trucks, millers, and the like.

Referring to FIG. 8, a method according to the present disclosure is shown in a flow chart format. The present disclosure provides a method for measuring the material swell of the load of material removed and transferred in the dump vehicle 300 by the work machine 100. The method includes the work machine 100 comprising the imaging device 114 that allows for continuous 3D image mapping around the work machine 100.

The method starts with a first step 800 of arriving at the site 200 with the work machine 100. The work machine 100 uploads a pre-existing site map similar to the first site scan 600 of the site 200, as indicated by a step 802. In some instances, the work machine 100 may already be located at the site 100. The pre-existing site map of the environment at the site 200 may be derived from a previous drone scan of the site 200, or what is otherwise available. The work machine 100 then locates its position at the site 200 in a step 804. The work machine 100 may have GPS capability for accurate location positioning at the site 200. If no pre-existing site map exists, then the imaging device 114 may begin by generating the first site scan 600 at the site 200. The pre-existing site map and a starting site map 600 may be identical.

The imaging device 114 then begins scanning the environment in a step 806 at the site 200 around the work machine 100 to create the first site scan 600. For example, the imaging device 114 would scan the environment, by taking images or videos, and update the work machine 100 with the current state of the environment at the site 102. A disparity may be computed of the volume removed from the site 200 by supporting software in the imaging device 114.

In a step 808, the work machine 100 then locates the dump vehicle 300 or other deposit site using the imaging device 114 and scans the dump bed 302 to generate the first bed scan 700 of the dump bed 302 in a step 810. The dump vehicle 300 may also be located or identified through a pre-existing site map, a driver app, image recognition, a GPS system, and/or vehicle fiducial marking, and the like. The dump bed 302 may be identified using machine learning generally known in the art. One skilled in the art may recognize that the dump vehicle 300 may be identified earlier or at any point in the method and scans the dump bed 302 for a first bed scan 700 as soon as the dump vehicle 300 is identified. Identifying the dump vehicle 300 allows the imaging device 114 to recall vehicle characteristics of the dump vehicle 300 such as weight limits and towing capacity.

Next, in a step 812, the work machine 100 begins digging and removes a load of bank material from the site 200. As a load of bank material is removed from the site 200, the imaging device 114 continuously scans by taking images of the site 200 around the work machine 100 and updating the new site scan 602 during operation as each load is removed from the site 200, in a step 814.

In a step 816, the disparity site map 604 is generated comparing the new site scan 602 with the first site scan 600. The disparity site map 604 demonstrates the difference in volume of material removed from the site 200 to obtain the bank volume 606 removed for each dig or load removed. The imaging device 114 records the disparity site map 604.

Afterwards, the work machine 100 dumps or transfers the load of excavated material into the dump bed 302 in a step 818. The imaging device 114 scans the dump bed 302 for a new bed scan 702 of the dump bed 302 in a step 818 to create 3D site maps of the dump bed 302, similar to the sitemaps of the site 200.

The new bed scan 702 is compared with the first bed scan 700. A disparity bed map 704 is generated for determining the excavated volume 706 of the load in the dump bed 302 in a step 822. The imaging device 114 computes the disparity of volume between the first bed scan 700 and the new bed scan 207 to obtain the excavated volume 706 of material transferred in the dump bed 302. The available empty volume in the dump bed 302 is reduced with each load of excavated material transferred in the dump bed 302. The imaging device 114 tracks the excavated volume 706 transferred in the dump bed 302 for each transfer of load.

Based on all of the foregoing, the present disclosure significantly improves upon the prior art by comparing the bank volume 606 removed from the site 200 with the excavated volume 706 of material in the dump bed 302 to determine the material swell for each load, in a step 824.

As shown by step 826, the work machine 100 may determine if the dump vehicle 300 has reached a max volume of material or a max weight capacity of material by using the material swell. The work machine 100 will cycles back and forth between removing the material from the site 200 and dumping or transferring loads of the now loose bank material, the excavated material, in the dump vehicle 300. The work machine 100 continues this cycle until the dump bed 302 does not have any available volume to receive any additional loads of material by weight or by volume. The work machine 100 may recall the dump vehicle 300 characteristics from identifying the dump vehicle 300 in step 808 to prevent overloading the dump vehicle 300.

In a step 828, an average material swell may be calculated when the dump vehicle 300 has been filled. The average material swell can be determined from a total bank volume removed from the site 200 and a total excavated volume transferred in the dump vehicle 300.

The material swell for each load and the filled dump vehicle 300 may be saved and tagged with a timestamp, GPS location of the removal site, and the vehicle identification numbers.

From the foregoing, it can be seen that the technology disclosed herein has industrial applicability in a variety of settings such as, but not limited to measuring the material swell of material removed from the site 200 and transferred to the dump vehicle 300.

It is valuable to determine, in real time, the material swell of site material removed from a dig or landscape site to avoid overloading the dump vehicles 300 which can cause it to be damaged and/or inoperable. Determining the material swell can also be valuable in ensuring dump vehicles comply with legal weight limits set by state and/or federal regulations for driving on local and federal roads.

Other aspects, objects and advantages of the present invention can be obtained from a study of the drawings, the disclosure and the appended claims.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of measuring material swell of material loaded in a dump vehicle using a work machine comprising a frame, an engine, a ground engaging element, and a working mechanism, the method comprising:
providing an imaging device on the work machine;
identifying the dump vehicle at the site;
scanning the site and the dump vehicle with the imaging device continuously during operation of the work machine;
removing a load of material from the site with the working mechanism and transferring the load into the dump vehicle;
calculating a bank volume of the load with the imaging device;
calculating an excavated volume of the load with the imaging device; and
calculating the material swell of the load with the imaging device.

2. The method according claim 1, wherein the method further comprise:
removing additional loads of material from the site and transferring the additional loads to the dump vehicle until the dump vehicle reaches a dump threshold;
calculating a final material swell of a total load volume transferred from the site and into the dump vehicle when the dump vehicle reaches the dump threshold.

3. The method according to claim 2, wherein the method further comprise:
scanning the site and dump vehicle by continuous 3D image mapping with the imaging device;
generating a disparity site map of the site to determine the bank volume from continuously 3D image mapping with the imaging device;
generating a disparity bed map of the dump vehicle to determine the excavated volume from continuously 3D image mapping with the imaging device; and
calculating the material swell by comparing the bank volume with the excavated volume;

4. The method according to claim 3, wherein the work machine further comprises a GPS location system, the method further comprising:
identifying the dump vehicle by an operator, a driver app, an image recognition feature, or by vehicle fiducial marking; and
recording the material swell and the final material swell with a timestamp, a GPS location tag of the site, and a vehicle identification number of the dump vehicle.

5. The method according to claim 4, wherein the dump vehicle comprises a dump bed, the method further comprising:
transferring the load of material into the dump bed of the dump vehicle.

6. The method according to claim 5, wherein the work machine is an excavator comprising the work mechanism further comprising a boom, an arm, and a bucket; and
the imaging device is a plurality of imaging devices mounted on a side of the boom and a side of the arm of the excavator.

7. The method according to claim 6, wherein the plurality of imaging devices are magnetically mounted on the work machine.

8. The method according to claim 7, wherein the plurality of imaging devices further comprising a plurality of stereo cameras; and
the stereo cameras further comprising at least one monochrome lens and at least one color lens.

9. A system comprising:
a dump vehicle;
a work machine comprising a frame, a ground engaging element supporting the frame for movement; an engine mounted in the frame; and
a working mechanism extending from the frame comprising a bucket and at least one imaging device for measuring a material swell of a load of material removed from a site during operation of the work machine, the at least one imaging device being configured to determine the material swell of the load by scanning the site continuously and scanning the dump vehicle continuously during operation of the work machine;
wherein the material swell is determined for each load removed from the site and transferred to the dump vehicle by comparing a bank volume of the load removed from the site determined by the imaging device and an excavated volume of the load transferred in the dump vehicle determined by the imaging device; and
wherein the imaging device is configured to use the material swell to monitor the dump vehicle to prevent overloading of the dump vehicle when transferring the load.

10. The system according to claim 9, wherein the continuous scanning of the imaging device is configured to continuously 3D map the site and the dump vehicle and generate 3D disparity maps to determine the bank volume removed from the site and the excavated volume transferred in the dump vehicle to calculate the material swell of the load.

11. The system according to claim 9, wherein the work machine is an excavator comprising a GPS location system;
the work mechanism further comprising a boom, an arm, and a bucket:
the imaging device is a plurality of imaging devices mounted on the boom and arm of the work mechanism;
the dump vehicle further comprising a dump bed;
wherein the excavator continues removing the load from the site and transfers the load to the dump bed until the dump bed is full and determines a final material swell of a total load volume transferred in the dump bed from the site to prevent overloading the dump vehicle.

12. The system according to claim 10, wherein the work machine is configured to identify the dump vehicle by an operator, a driver app, an image recognition feature, or vehicle fiducial marking.

13. The system according to claim 10, wherein the imaging devices further comprising a plurality of stereo cameras magnetically mounted on the boom and the arm;
the stereo cameras further comprising at least one monochrome lens and at least one color lens.

14. The system according to claim 10, wherein the imaging device is configured to identify the dump vehicle image recognition feature or vehicle fiducial marking and recall the weigh and volume capacity of the dump vehicle.

15. The system according to claim 11, wherein the imaging device is configured to record and track the material swell with a timestamp, a GPS location tag of the site, and a vehicle identification number of the dump vehicle.

16. A work machine comprising:
a frame;
a ground engaging element supporting the frame for movement;
an engine mounted on the frame;
a working mechanism extending from the frame comprising a bucket; and
at least one imaging device for measuring a material swell of a load of material removed from a site and transferred to a dump vehicle during operation of the work machine by continuously scanning the site and the dump vehicle.

17. The work machine according to claim 16, wherein the work machine is an excavator comprising a boom and an arm, at least one imaging device is mounted on the boom or the arm.

18. The work machine according to claim 17, wherein the at least one imaging device is a stereo camera comprising an at least one monochrome lens and an at least one color lens.

19. The work machine according to claim 17, wherein the at least one imaging device comprises a processor capable of generating 3D point maps of the site and the dump vehicle, the processor is capable of generating a disparity maps of the site and the dump vehicle.

20. The work machine according to claim 19, wherein the dump vehicle further comprising a dump bed, and the at least one imaging device comprises an image recognition system for identifying the dump vehicle and a dump bed of the dump vehicle.
